(19) United States
(12) Patent Application Publication
(10) Pub. No.: US 2025/0109998 A1
(43) Pub. Date: Apr. 3, 2025

(54) Micro-Ring Resonator Strain Sensors for In-Situ Stress Monitoring

(71) Applicant: Intel Corporation, Santa Clara, CA (US)

(72) Inventors: Vanessa POGUE, Tucson, AZ (US); Hari MAHALINGAM, San Jose, CA (US); Joshua JOHNSON, Chandler, AZ (US); Jordan DAVIS, Santa Clara, CA (US); Ranjeet KUMAR, Milpitas, CA (US); Yen-Jung CHEN, San Jose, CA (US); Andrew DEVINE, Santa Clara, CA (US); Mahtab HAKAMI, Santa Clara, CA (US)

(21) Appl. No.: 18/374,683

(22) Filed: Sep. 29, 2023

(51) Int. Cl. G01L 1/24

(52) U.S. Cl. CPC G01L 1/24

(57) ABSTRACT

The present disclosure is directed to testing vehicles for optical devices and other semiconductor devices that have insitu sensor units for measuring localized strains, and methods for their use. In an aspect, the optical device may include a photonic integrated circuit device having several components including a laser, an optical amplifier, a waveguides, a modulator, a demodulator, and photodetectors. In another aspect, the sensor unit may include a micro-ring resonator strain sensor, an input grating coupler and an output grating coupler that are coupled to the micro-ring resonator strain sensor, for which the input grating coupler is coupled to a light source and the output grating coupler is coupled to an optical power meter. In yet another aspect, the sensor unit may include a temperature calibration unit having a heater and a temperature diode.

### BACKGROUND

For integrated circuit design and fabrication, the need to improve performance and lower costs are constant challenges. The high-volume manufacturing (HVM) of semiconductor packages may produce yield losses caused by package warpage during the assembly and packaging processes. Package warpage may be the result of multiple factors, such as coefficient of thermal expansion (CTE) mismatches, the stack-up of different types of components, and the various thermal processing steps that the semiconductor packages undergo during the assembly process and the strains resulting therefrom.

Photonic integrated circuits (PICs) are very sensitive to mechanical stress and strains that may be caused by warpage during assembly and packaging processes. PICs yields may be reduced by device failures depending on the types of stresses and strains and the magnitude of such stresses and strains. The present approach to characterizing such mechanical stresses and strains is to use warpage-based laboratory techniques, e.g., shadow-moire, interferometry, fringe projection, etc., to determine warpage of PICs at various stages of the HVM assembly and packaging processes and to estimate the strains through modeling methods.

Moreover, the present warpage-based tool measurements are only able to provide shape change, i.e., warpage measurement on full fields, at a given processing point and cannot be used to determine contemporaneously the localized strains during assembly or packaging processes, since a testing unit must be moved from a production tool to a different testing tool and measurements are based on full fields. In addition, after the PIC is packaged, it is often occluded and cannot be accessed for warpage measurements. Hence, the present approaches are unable to provide a continuous, direct measurement of strains for an optical semiconductor device and other devices.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. The dimensions of the various features or elements may be arbitrarily expanded or reduced for clarity. In the following description, various aspects of the present disclosure are described with reference to the following drawings, in which:

FIG. 1 shows an exemplary representation of a present testing vehicle with a micro-ring resonator strain sensor according to an aspect of the present disclosure;

FIG. 2 shows an exemplary representation of a present micro-ring resonator strain sensor according to an aspect of the present disclosure;

FIG. 3 shows an exemplary representation of a schematic layout with a present micro-ring resonator strain sensor according to an aspect of the present disclosure;

FIG. 4 shows an exemplary representation of a testing station for a present test vehicle with a micro-ring resonator strain sensor according to an aspect of the present disclosure;

FIG. 5 shows an exemplary representation of strain measurements obtained with a present micro-ring resonator strain sensor according to an aspect of the present disclosure;

FIG. 6 shows an exemplary representation of strain measurements obtained with a present micro-ring resonator strain sensor according to another aspect of the present disclosure;

FIG. 7 shows an exemplary representation of strain measurements obtained with a present micro-ring resonator strain sensor according to yet another aspect of the present disclosure;

FIGS. 8, 8A, and 8B show an exemplary representation of a schematic layout of a present testing vehicle according to an aspect of the present disclosure; and

FIG. 9 shows a simplified flow diagram for an exemplary method according to an aspect of the present disclosure.

### DETAILED DESCRIPTION

The following detailed description refers to the accompanying drawings that show, by way of illustration, specific details, and aspects in which the present disclosure may be practiced. These aspects are described in sufficient detail to enable those skilled in the art to practice the present disclosure. Various aspects are provided for devices, and various aspects are provided for methods. It will be understood that the basic properties of the devices also hold for the methods and vice versa. Other aspects may be utilized and structural, and logical changes may be made without departing from the scope of the present disclosure. The various aspects are not necessarily mutually exclusive, as some aspects can be combined with one or more other aspects to form new aspects.

According to the present disclosure, a present in-situ or integrated strain measurement sensor may be used to quantify the amount of mechanical strain within different regions of a silicon chip/die and provide strain characterization at various stages of an assembly and packaging operation. For example, by monitoring the mechanical strain in conjunction with a photonic integrated circuit (PIC) device's performance within a silicon chip, the present in-situ strain measurement sensor enables the study of the sensitivity of PIC performance to mechanical stresses, thereby enabling the identification of tolerances and thresholds that are likely to cause failure, which can lead to improved PIC device and packaging designs. In addition, the present strain measurement sensor may be used for reliability and operational testing, e.g., general operations of a semiconductor device or for a specific end-user application, for measuring strain in a die or die package that includes a strain-sensitive device. The silicon chip may be a test vehicle or a product die.

In an aspect, the present in-situ strain measurement sensor may include a micro-ring resonator optical sensor that may be designed into an optomechanical testing vehicle for a PIC. For example, the present in-situ strain measurement sensor may be used in any optical-based testing vehicles built for optical transceivers, co-packaged optics, LiDAR, and optical communications and metrology applications. The use of the present in-situ sensors may enable many more architectural packaging options for a variety of semiconductor devices, including photonic integrated circuits, thereby reducing their cost and improving yield.

The present disclosure provides a die having a semiconductor device, including photonic integrated circuits, and a micro-ring resonator sensor unit for measuring strain, for which the micro-ring resonator sensor unit is integrated into a layout for the PIC or other semiconductor device. In an aspect, the micro-ring resonator sensor unit includes a first ring waveguide section, a second waveguide section, and a third waveguide section.

The present disclosure is also directed to a method that includes providing a semiconductor wafer, forming a plurality of semiconductor devices on the semiconductor wafer, forming a plurality of micro-ring resonator strain sensors on the semiconductor wafer, performing one or more semiconductor processing operations with the semiconductor wafer; and measuring strain forces on the plurality of semiconductor devices using the micro-ring resonator strain sensors.

The present disclosure is further directed to a test device, which may be an optomechanical testing vehicle, that includes a sensor unit having a micro-ring resonator component, an input component and output component, and a photonic integrated circuit. In an aspect, the micro-ring resonator sensor unit is integrated into the design layout of the photonic integrated circuit provided on the test device. The test device may be a product die taken as a sample used to check for performance quality.

The technical advantages of the present disclosure include, but are not limited to:
(i) providing in-situ sensors for measuring, quantifying, and characterizing mechanical strain within localized regions of PICS;
(ii) providing designers with test vehicles that are able to determine strain thresholds that may lead to the failure of a device by “de-risking” device performance issues due to packaging and to development of improved packaging schemes;
(iii) providing engineers with more effective test vehicles that may accelerate a PIC's and a PIC's package development process; and
(iv) providing the potential to reduce high-cost manufacturing steps through optimization for the reduction of strains within a die.

To more readily understand and put into practical effect the present micro-ring resonator strain sensors and methods, which may provide improved warpage characterization and testing, particular aspects will now be described by way of examples provided in the drawings that are not intended as limitations. The advantages and features of the aspects herein disclosed will be apparent through reference to the following descriptions relating to the accompanying drawings. Furthermore, it is to be understood that the features of the various aspects described herein are not mutually exclusive and can exist in various combinations and permutations. For the sake of brevity, duplicate descriptions of features and properties may be omitted.

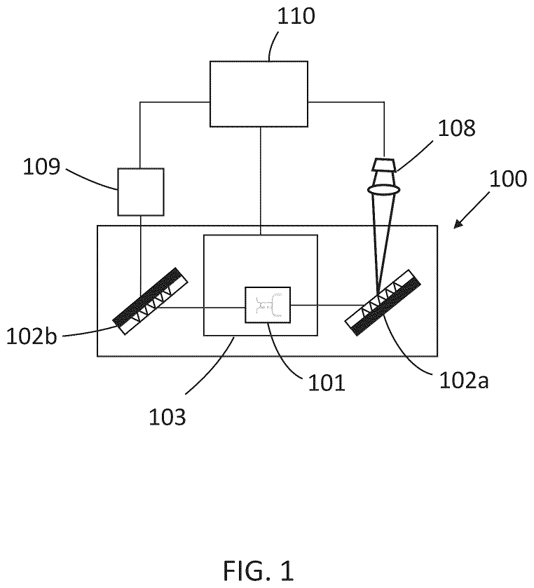

FIG. 1 shows an exemplary representation of a present testing or test vehicle 100, or a production die, with a micro-ring resonator strain sensor 101 according to an aspect of the present disclosure. The testing vehicle 100 may have a semiconductor device 103 that is “integrated” or placed “in-situ” together with the micro-ring resonator strain sensor 101. The semiconductor device 103 may be a photonic integrated circuit (PIC) that includes a laser, an optical amplifier, a waveguide, a modulator, a demodulator, photodetectors, and other components directed to its specific application. In another aspect, the semiconductor device 103 may include any semiconductor device that is sensitive to stresses and strains, e.g., FinFETs, III-V nitride-based devices, and other thin film devices, and that may be fabricated using a silicon-on-insulator, Si, SiN, or SiON process flow, as part of a process that incorporates the present micro-ring resonator strain sensor 101.

In an aspect, the testing vehicle 100 may have an input grating coupler 102a and an output grating coupler 102b that are coupled with the micro-ring resonator strain sensor 101. In another aspect, the input and output grating couplers 102a and 102b, respectively, may be positioned remotely from the micro-ring resonator strain sensor 101. In an aspect, the test vehicle 100 may use any spot-sized light converter (e.g., edge coupler) in place of a grating coupler.

In an aspect, the testing vehicle 100 may have the input grating coupler 102a coupled a laser 108 providing a light source, and the output grating coupler 102b may be coupled with an optical power meter 109. The input grating coupler 102a and output grating coupler 102b provide effective coupling of the light in the free space between the present micro-ring resonator strain sensor 101 and the laser 108 and from the present micro-ring resonator strain sensor 101 to the optical power meter 109. The micro-ring resonator strain sensor 101 and its associated components, including the input and output grating couplers 102a and 102b, may be integrated into a layout for the PIC 103 and fabricated together. In another aspect, a controller or processor 110 may be coupled to the testing vehicle 100, which may include connections to the PIC 103, the laser 108, and the optical power meter 109. In yet another aspect, the testing vehicle 100 may have a tunable laser and a power meter (both not shown) that may be integrated, i.e., built-in and fabricated with the micro-ring resonator strain sensor 101 and its associated components.

According to the present disclosure, strain measurements may be obtained using a present micro-ring resonator strain sensor and characterized using Equation 1 below:

$$ε = \frac{Δ L}{L} \qquad ( Eq . 1 )$$

where strain (ε) in a material is equal to the change of length (ΔL) per unit of the original length (L). In an aspect, the strain data collection may be very fast being an optical sensor device, and will not be affected by EM interference.

It is understood that PICs may be used for optical fiber and free-space optical communications, signal processing, optical metrology computing, and amplification, as well as the generation, detection, and manipulation of photons. A PIC may include various components such as lasers, optical amplifiers, waveguides, modulators, demodulators, photodetectors, etc.

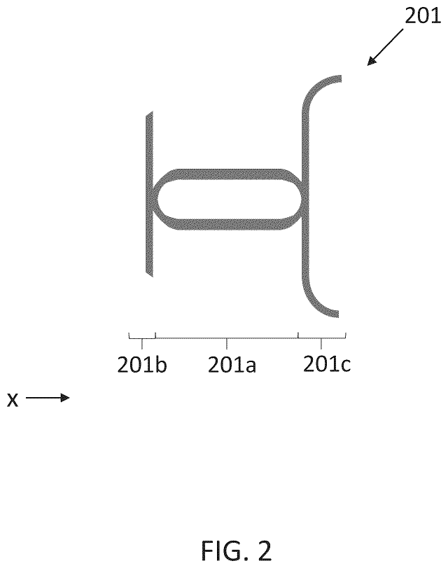

FIG. 2 shows an exemplary representation of a present micro-ring resonator strain sensor 201 according to an aspect of the present disclosure. The micro-ring resonator strain sensor 201 may have a first ring waveguide section 201a, a second waveguide section 201b, and a third waveguide section 201c. In this aspect, the first ring waveguide section 201a is configured as a ring to allow for resonance, the third waveguide section 201c is configured to allow light to enter the first ring waveguide section 201a, and the second waveguide section 201b is configured to allow the resonance frequency to enters and then be absorbed into a test vehicle, product die, or die package as these waveguides are terminated. In an aspect, the micro-ring resonator strain sensor 201 may be a patterned channel waveguide that may be circular, elliptical and/or other shapes, as well as generally uniform cross-sections.

In another aspect, the micro-ring resonator strain sensor 201 may have, for example, a length that ranges from 300 um to 400 um, with the first ring waveguide section 201a having, for example, a ring circumference from 150 um to 600 um. It should be understood that a present micro-ring resonator strain sensor may have a size that is optimized for a particular semiconductor device (i.e., the micro-ring resonator strain sensor may be smaller or larger depending on the available real estate for the particular semiconductor device) since the selected size will affect the sensitivity of the micro-ring resonator strain sensor (i.e., a smaller size will reduce the sensitivity to strain). In an aspect, the present micro-ring resonator strain sensors may have a stress sensitivity performance of approximately 0.5 pm/microstrain (με) and a range of resolution of approximately 25 ustrain-200 ustrain.

In an aspect, the micro-ring resonator strain sensor 201 may have an orientation in an x-axial direction as shown, while a further micro-ring resonator strain sensor (not shown) may have another orientation, e.g., a y-axial direction. In aspect, one or more micro-ring resonator strain sensors may be positioned to obtain mechanical strain measurements in specific crystallographic directions, for example, in the <100> and <110> direction indices, which may correspond to an x-direction and a y-direction on a die or wafer. For example, a plurality of micro-ring resonator strain sensors may be placed in different locations and directions to get data in both the x-direction and the y-direction for a full 2D stress tensor. It may also be possible to obtain a full 3D stress tensor with the present micro-ring resonator strain sensors placed in the z-direction as well.

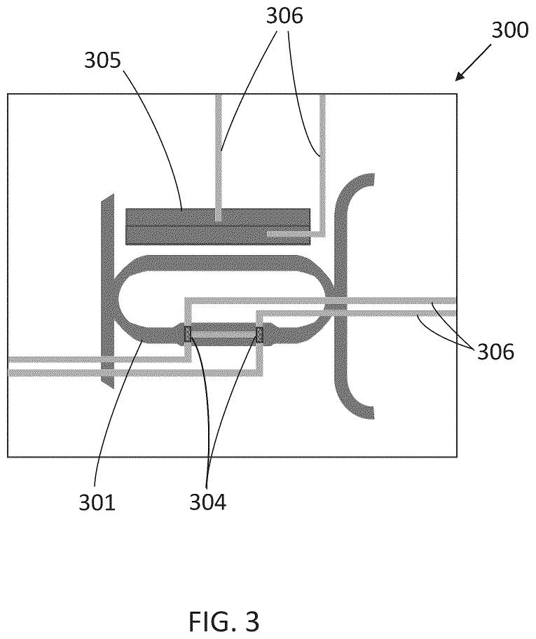

FIG. 3, shows an exemplary representation of a partial layout diagram of semiconductor device 300 with a present micro-ring resonator strain sensor 301 according to an aspect of the present disclosure. The semiconductor device 300 may be a pre-production testing vehicle or a production die or wafer used to undergo measurement for mechanical stress and strain.

In an aspect shown in FIG. 3, the present micro-ring resonator strain sensor 301 may include heaters 304 (e.g., a resistive or other type of heater) and a temperature diode 305 that provide control and monitoring of the temperature of the semiconductor device 300, as a heat monitoring and control unit, during strain measurements because the present micro-ring resonator strain sensor 301 is sensitive to temperature changes. By calibrating for the effect of temperature on the wavelength shift and monitoring the temperature during strain measurements, the effects of temperature may be understood and potentially extracted from final strain measurements. In an aspect, the heaters 304 and a temperature diode 305 may be coupled to metallization lines 306, which may be used to provide connections to a power source. The micro-ring resonator strain sensor 301, the heaters 304, the temperature diode 305, and the input and output grating couplers (not shown) may constitute a micro-ring resonator sensor unit for measuring strain, which may be integrated into the layout for the semiconductor device 300.

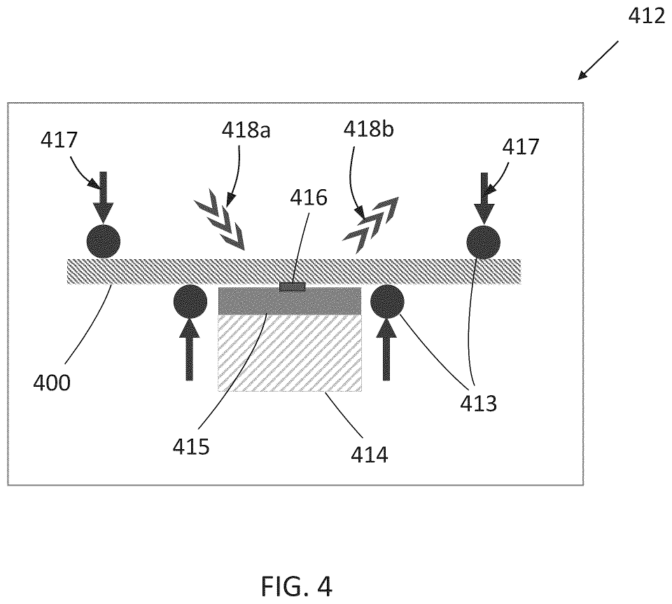

FIG. 4, shows an exemplary representation of a testing apparatus or station 412 for a present test vehicle or a product die 400 having an integrated or in-situ micro-ring resonator strain sensor (not shown) according to an aspect of the present disclosure. In an aspect, an external high-resolution tunable laser (not shown) may provide light (shown as 418a) to input grating couplers (not shown) that travels to the micro-ring resonator strain sensor via waveguides or fiber optic lines (not shown) on the test vehicle 400 and an output may be collected by an output grating coupler (not shown). An output light (shown as 418b) may be measured using a high-resolution optical power meter (not shown).

In an aspect, a product die may be tested before, during, and/or after various semiconductor processing operations including semiconductor device assembly, wafer dicing, and packaging of the semiconductor device. It may be necessary to perform measurements for mechanical stresses and strains resulting from processes requiring heating of the product die or packaged die. In another aspect, a testing station may be configured to test dies on a wafer before dicing.

In another aspect, an external mechanical tensile strain or compressive strain may be applied by the testing apparatus 412 to a PIC (not shown) on the test vehicle 400 using, for example, a four-point bend fixture 413 that applies a uniform force (shown as 417) to the test vehicle 400. The force 417 may be measured and controlled using an attached piezo-resistive sensor or strain gauge 416 that may be positioned on a bottom side of the test vehicle 400. In a further aspect, the testing station 412 may have a cooling block 414 with a thermal interface material 415 that removes any excess heat and supports the test vehicle 400. Through repeated testing, the strain values (tensile or compressive) that may potentially lead to the failure of an on-chip device, such as a PIC, can be determined.

When a present integrated or in-situ micro-ring resonator strain sensor is subjected to mechanical strain, its wavelength resonances will shift due to changes in the length of the sections of the micro-ring resonator strain sensor (e.g., a circumference change), its refractive index will also change due to the photoelastic effect, and due to dispersion. These changes can be characterized by Equation 2 below:

$$\frac{\partial {λ}_{m}}{\partial {ε}_{x}} = \frac{{n}_{s}}{〈 {n}_{g} 〉} ( \frac{{λ}_{c}}{{n}_{s}} \frac{\partial {n}_{s}}{\partial {ε}_{x}} + {λ}_{c} ) \qquad ( Eq . 2 )$$

where λₘ is the resonance wavelength, εₓ is the in-plane direction of the waveguide sections as shown, for example in FIG. 2, nₛ is the effective index of the long straight waveguide, n_{g} is the group index, and λ_{c} is resonance wavelength without deformation. Equation 2 may be used to capture the effects due to dispersion, effective index change, and track length change and model the strains on a test vehicle or production die.

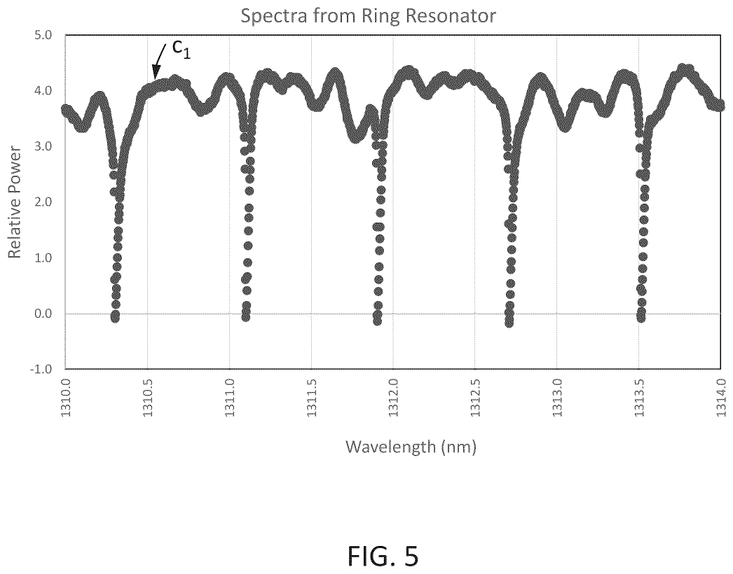

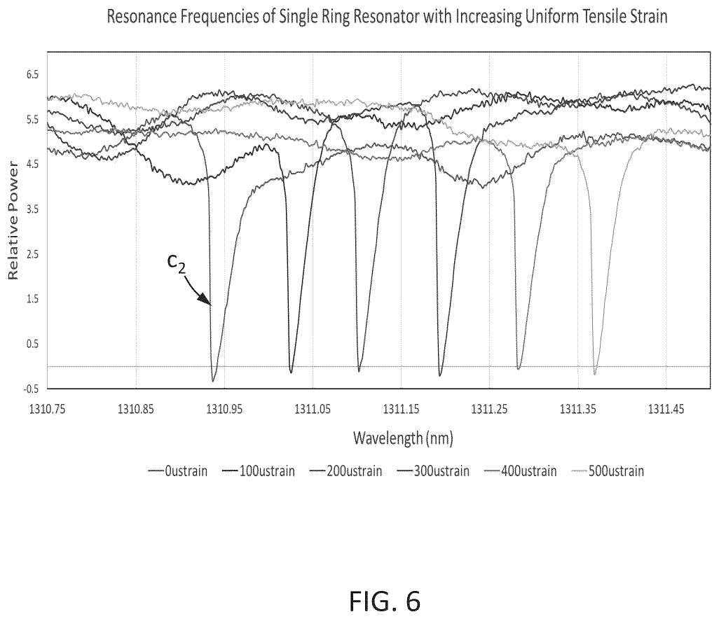

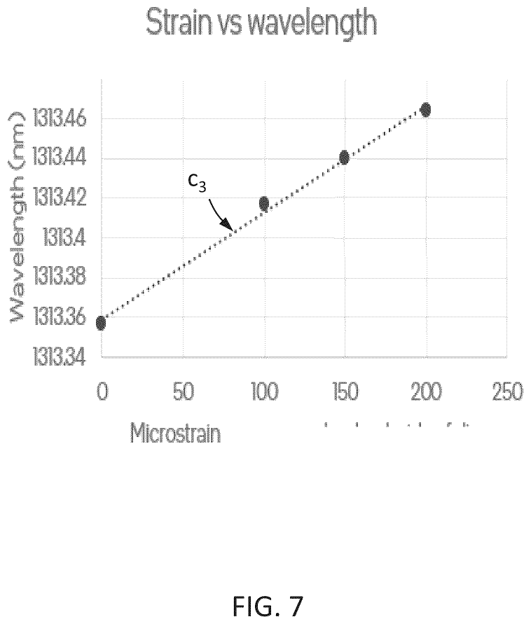

FIGS. 5, 6, and 7 show exemplary representations of different strain measurements obtained with a present micro-ring resonator strain sensor according to an aspect of the present disclosure. In FIG. 5, a full spectrum C₁ was obtained using a present micro-ring resonator strain sensor at 0με that shows periodic drops in optical power at different resonance wavelengths. In FIG. 6, a curve C₂ shows one of the optical resonance wavelengths shifting under increased tensile mechanical strain. In FIG. 7, a curve C₃ provides a plot of the average resonances of several sweeps collected at different loading conditions, which shows a clear linear trend and a shift of 50 picometers (pm) of wavelength shift per 100με (microstrain). The ratio of wavelength shift to microstrain may be predicted and correlated based on a micro-ring resonator strain sensor's design dimensions.

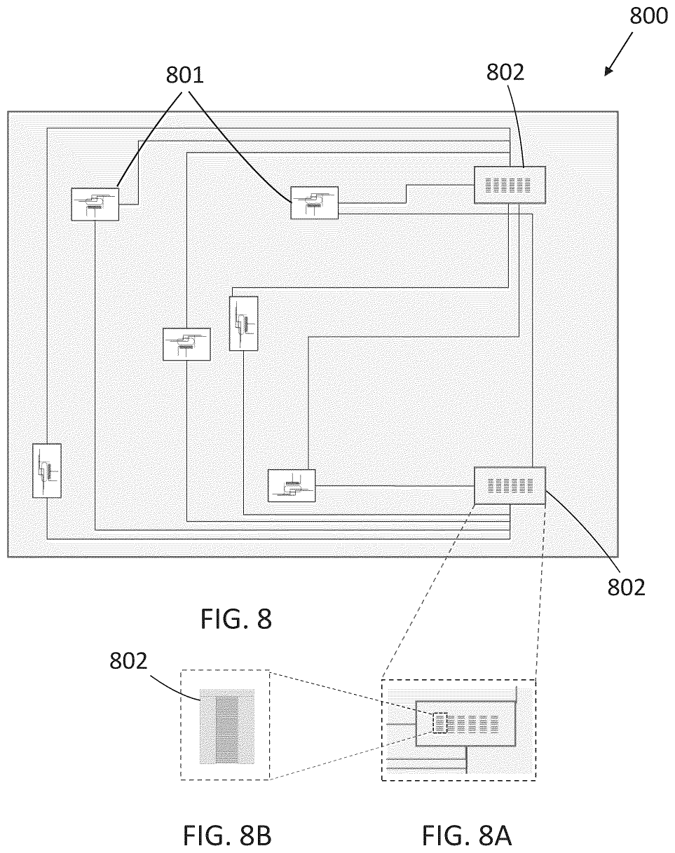

FIGS. 8, 8A, and 8B show an exemplary representation of a layout of a present test vehicle 800 according to an aspect of the present disclosure. As shown in FIG. 8, the test vehicle 800 may have a plurality of micro-ring resonator strain sensors 801 and a plurality of grating couplers 802. The plurality of micro-ring resonator strain sensors 801 and the plurality of grating couplers 802 are integrated into the layout for the test vehicle 800 and may be fabricated together. In FIG. 8A, an expanded view of the plurality of grating couplers is shown, and in FIG. 8B, an expanded view of a single grating coupler is shown. In addition, the plurality of grating couplers 802 may be positioned apart from the plurality of micro-ring resonator strain sensors 801. The light travels from the grating couplers to each of the micro-ring resonators via waveguides (not shown).

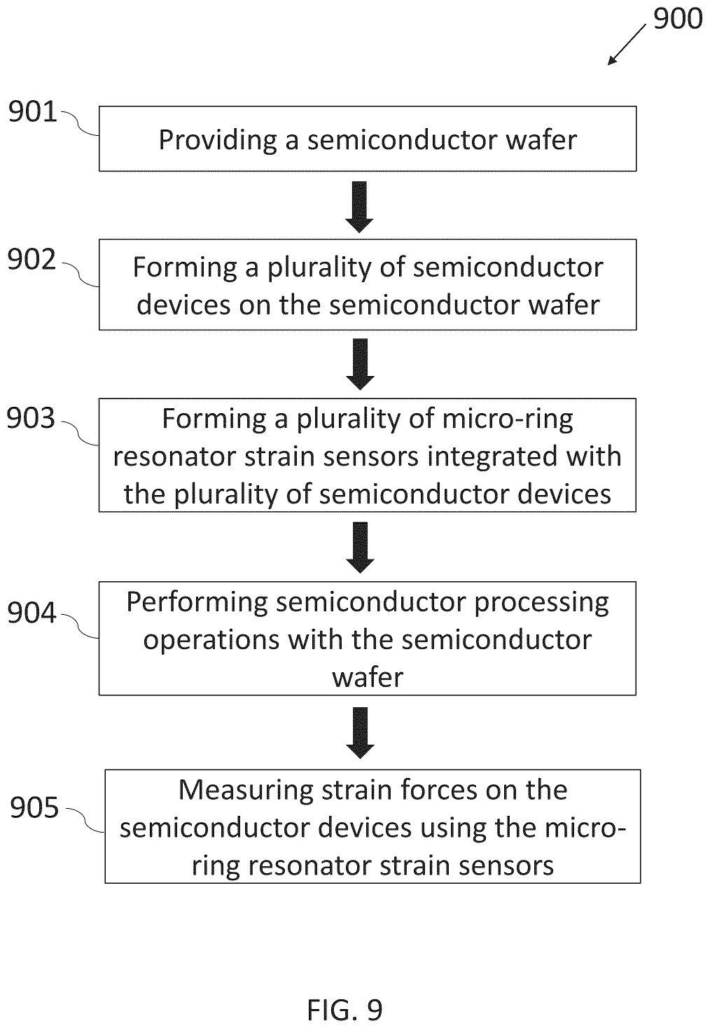

FIG. 9 shows a simplified flow diagram for an exemplary method 900 according to an aspect of the present disclosure.

The operation 901 may be directed to providing a semiconductor wafer.

The operation 902 may be directed to forming a plurality of semiconductor devices on the semiconductor wafer.

The operation 903 may be directed to forming a plurality of micro-ring resonator strain sensors integrated with the plurality of semiconductor devices.

The operation 904 may be directed to performing semiconductor processing operations with the semiconductor wafer measuring strain forces on the semiconductor devices using the micro-ring resonator strain sensors.

The operation 905 may be directed to measuring the strain forces on the semiconductor devices using the micro-ring resonator strain sensors. The measurements for strain forces may be performed before, during, and/or after a semiconductor processing operation, and/or performed for reliability and operational testing, including operations of a semiconductor device for an end-user application.

It will be understood that any property described herein for a particular strain sensor unit and method for measuring strain in a photonic integrated circuit device may also hold for any optical device using the present sensors described herein. It will also be understood that any property described herein for a specific method may hold for any of the methods described herein. Furthermore, it will be understood that for any photonic integrated circuit and the methods described herein, not necessarily all the components or operations described will be shown in the accompanying drawings or method, but only some (not all) components or operations may be disclosed.

To more readily understand and put into practical effect the test vehicles having present strain sensors, they will now be described by way of examples. For the sake of brevity, duplicate descriptions of features and properties may be omitted.

### Examples

Example 1 provides a die including a semiconductor device, and a micro-ring resonator sensor unit for measuring strain, for which the micro-ring resonator sensor unit is integrated into a layout for the semiconductor device.

Example 2 may include the die of example 1 and/or any other example disclosed herein, for which the semiconductor device includes a photonic integrated circuit.

Example 3 may include the die of example 1 and/or any other example disclosed herein, for which the micro-ring resonator sensor unit includes a first ring waveguide section, a second waveguide section, and a third waveguide section.

Example 4 may include the die of example 1 and/or any other example disclosed herein, for which the micro-ring resonator sensor unit includes an input grating coupler coupled to the micro-ring resonator sensor unit and a light source.

Example 5 may include the die of example 4 and/or any other example disclosed herein, for which the micro-ring resonator sensor unit further includes an output grating coupler coupled to the micro-ring resonator sensor and an optical power meter.

Example 6 may include the die of example 1 and/or any other example disclosed herein, for which the micro-ring resonator sensor unit includes a heater.

Example 7 may include the die of example 6 and/or any other example disclosed herein, for which the micro-ring resonator sensor unit further includes a temperature diode.

Example 8 may include the die of example 1 and/or any other example disclosed herein, for which the die is an optomechanical test vehicle with the micro-ring resonator sensor unit and the semiconductor device integrated into the optomechanical test vehicle.

Example 2 may include the die of example 1 and/or any other example disclosed herein, for which the die is a product die with the micro-ring resonator sensor unit and the semiconductor device integrated into the product die.

Example 10 provides a method including providing a semiconductor wafer, forming a plurality of semiconductor devices on the semiconductor wafer, forming a plurality of micro-ring resonator strain sensors integrated with the plurality of semiconductor devices on the semiconductor wafer, performing one or more semiconductor processing operations using the semiconductor wafer, and obtaining measurements for strain forces on the plurality of semiconductor devices using the plurality of micro-ring resonator strain sensors.

Example 11 may include the method of example 10 and/or any other example disclosed herein, for which the obtaining measurements for strain forces includes affecting strains on one or more of the plurality of semiconductor devices, providing a light as an input to one or more of the micro-ring resonator strain sensors, and measuring an output from the one or more of the micro-ring resonator strain sensors.

Example 12 may include the method of example 11 and/or any other example disclosed herein, which further includes forming a heater and a temperature diode coupled with each of the plurality of micro-ring resonator strain sensors on the semiconductor wafer and controlling and monitoring temperature of each of the plurality micro-ring resonator strain sensors, for which the measurements of the strain forces are calibrated for an effect from temperature.

Example 13 may include the method of example 11 and/or any other example disclosed herein, for which the obtaining measurements for strain forces includes positioning one or more of the plurality of semiconductor devices at a testing station, for which the light is provided by a laser and the measuring of the output is performed by an optical power meter at the testing station.

Example 14 may include the method of example 11 and/or any other example disclosed herein, for which the obtaining measurements for strain forces is performed before, during, and/or after a semiconductor processing operation, for which the semiconductor processing operation includes one of a plurality of processing steps for assembly and packaging of the semiconductor device, and/or performed for reliability and operational testing.

Example 15 provides a test device including a sensor unit having a micro-ring resonator component, an input component and output component, and a photonic integrated circuit.

Example 16 may include the test device of example 15 and/or any other example disclosed herein, for which the sensor unit further includes a heater and a temperature diode.

Example 17 may include the test device of example 15 and/or any other example disclosed herein, for which the micro-ring resonator component further has a length in a range of approximately 300 um to 400 um.

Example 18 may include the test device of example 15 and/or any other example disclosed herein, for which the micro-ring resonator component further includes a ring waveguide section with a ring circumference having a range of approximately 150 um to 600 um.

Example 19 may include the test device of example 15 and/or any other example disclosed herein, for which the testing device is an optomechanical testing vehicle with the micro-ring resonator sensor unit integrated into the photonic integrated circuit.

Example 20 may include the test device of example 19 and/or any other example disclosed herein, for which the photonic integrated circuit includes integrated circuits used for optical transceivers, co-packaged optics, LiDAR, optical fiber communications, and metrology applications.

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise” and “comprises”.

The term “coupled” (or “connected”) herein may be understood as electrically coupled or as mechanically coupled, e.g., attached or fixed or attached, or just in contact without any fixation, and it will be understood that both direct coupling or indirect coupling (in other words: coupling without direct contact) may be provided.

The terms “and” and “or” herein may be understood to mean “and/or” as including either or both of two stated possibilities.

While the present disclosure has been particularly shown and described with reference to specific aspects, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

What is claimed is:

1. A die comprising:
a semiconductor device; and
a micro-ring resonator sensor unit for measuring strain, wherein the micro-ring resonator sensor unit is integrated into a layout for the semiconductor device.

2. The die of claim 1, wherein the semiconductor device comprises a photonic integrated circuit.

3. The die of claim 1, wherein the micro-ring resonator sensor unit comprises a first ring waveguide section, a second waveguide section, and a third waveguide section.

4. The die of claim 1, wherein the micro-ring resonator sensor unit comprises an input grating coupler coupled to the micro-ring resonator sensor unit and a light source.

5. The die of claim 4, wherein the micro-ring resonator sensor unit further comprises an output grating coupler coupled to the micro-ring resonator sensor and an optical power meter.

6. The die of claim 1, wherein the micro-ring resonator sensor unit comprises a heater.

7. The die of claim 6, wherein the micro-ring resonator sensor unit further comprises a temperature diode.

8. The die of claim 1, wherein the die is an optomechanical test vehicle with the micro-ring resonator sensor unit and the semiconductor device integrated into the optomechanical test vehicle.

9. The die of claim 1, wherein the die is a product die with the micro-ring resonator sensor unit and the semiconductor device integrated into the product die.

10. A method comprising:
providing a semiconductor wafer;
forming a plurality of semiconductor devices on the semiconductor wafer;
forming a plurality of micro-ring resonator strain sensors integrated with the plurality of semiconductor devices on the semiconductor wafer;
performing one or more semiconductor processing operations using the semiconductor wafer; and
obtaining measurements for strain forces on the plurality of semiconductor devices using the plurality of micro-ring resonator strain sensors.

11. The method of claim 10, wherein the obtaining measurements for strain forces comprises:
affecting strains on one or more of the plurality of semiconductor devices;
providing a light as an input to one or more of the micro-ring resonator strain sensors; and
measuring an output from the one or more of the micro-ring resonator strain sensors.

12. The method of claim 11, further comprises:
forming a heater and a temperature diode coupled with each of the plurality of micro-ring resonator strain sensors on the semiconductor wafer; and
controlling and monitoring temperature of each of the plurality micro-ring resonator strain sensors, wherein the measurements of the strain forces are calibrated for an effect from temperature.

13. The method of claim 11, wherein the obtaining measurements for strain forces comprises positioning one or more of the plurality of semiconductor devices at a testing station, wherein the light is provided by a tunable laser and the measuring of the output is performed by an optical power meter at the testing station.

14. The method of claim 11, wherein the obtaining measurements for strain forces is performed before, during, or after a semiconductor processing operation, wherein the semiconductor processing operation comprises one of a plurality of processing steps for assembly and packaging of the semiconductor device, and/or performed for reliability and operational testing.

15. A test device comprising:
a sensor unit comprising a micro-ring resonator component, an input component, and an output component; and
a photonic integrated circuit.

16. The test device of claim 15, wherein the sensor unit further comprises a heater and a temperature diode.

17. The test device of claim 15, wherein the micro-ring resonator component has a length in a range of approximately 300 um to 400 um.

18. The test device of claim 15, wherein the micro-ring resonator component further comprises a ring waveguide section with a ring circumference having a range of approximately 150 um to 600 um.

19. The test device of claim 15, wherein the testing device is an optomechanical testing vehicle comprising the micro-ring resonator sensor unit being integrated into the photonic integrated circuit.

20. The testing device of claim 19, wherein the photonic integrated circuit comprises integrated circuits used for optical transceivers, co-packaged optics, LiDAR, and optical fiber communications and metrology applications.
